(19) United States
(12) Patent Application Publication
(10) Pub. No.: US 2005/0068950 A1
(43) Pub. Date: Mar. 31, 2005

(54) Structured private addressing and naming for management of service and network resources

(75) Inventors: Donald Russell Ellis, Ottawa (CA); Martin Charbonneau, Hull (CA); Marc Holness, Ottawa (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Nortel Networks Limited, St. Laurent (CA)

(21) Appl. No.: 10/784,332

(22) Filed: Feb. 23, 2004

Related U.S. Application Data
(60) Provisional application No. 60/507,278, filed on Sep. 30, 2003.

(51) Int. Cl. H04L 12/28

(52) U.S. Cl. 370/389; 709/245

(57) ABSTRACT

Described are a system and method for identifying private resources associated with a communications network. A structured address format is defined having a plurality of character positions. Each character position is associated generally with a property of a managed resource in the communications network. A structured private address, constructed according to the structured address format, is assigned to the managed resource. Each character position of the assigned structured address has a value that identifies a specific instance of the property of the managed resource associated with that character position. Operations Systems Support (OSS) gives a common name to the managed resource and maintains an association between the common name and the structured address. The structured address format can follow a four-byte dotted decimal notation similar to IPv4 addresses. For addresses following this format, the OSS can use standard domain name system services to translate between common names and structured addresses.

### RELATED APPLICATION

This application claims the benefit of the filing date of U.S. Provisional Application Ser. No. 60/507,278, filed Sep. 30, 2003, titled “Structured Addressing for Optical Service and Network Management Objects,” the entirety of which provisional application is incorporated by reference herein.

### FIELD OF THE INVENTION

The invention relates generally to communications networks. More particularly, the invention relates to a system and method of managing service resources and network resources in private telecommunication networks using structured private addressing and common naming to identify logical and physical resources in such networks.

### BACKGROUND

The communications industry uses a variety of numbering schemes for identifying and inventorying network resources. Current inventory management systems use Common Language Equipment Identification or CLEI codes for precisely identifying form, fit, and function of specific equipment items used in circuit-switched and packet-switched, wire line and wireless, Public Switched Telephone Network or PSTN, Digital Private Line (PL) networking, Optical networking, Digital Subscriber Line, Frame Relay, Asynchronous Transport Mode (ATM), Internet Protocol and Multiprotocol Label Switching (IP/MPLS) technologies. Common Language Location Identification or CLLI codes identify and describe network sites, network support sites, and locations of offices and equipment. Another numbering scheme, Network Service Access Protocol (NSAP), identifies network endpoints used in Opens Systems Interconnection (OSI) networking.

As an example of an implementation of a present-day numbering scheme, FIG. 1 shows a network 2 having a plurality of private local-area networks or LANs 10 in communication with each other over a service provider network 12. To support service traffic from the LANs 10, the service provider (SP) network 12 includes edge-service network elements (NEs) 14, 14′ and a plurality of core NEs 18, together managed as an SP private network. Each edge-service NE 14, 14′ has a tributary interface 20 in communication with one of the LANs and a line interface 22 for communicating over the network 12. The core NEs 18 also have line interfaces 24 for carrying service traffic between the LANs 10. Various numbering codes are used to identify the NEs 14, 14′, 18, interfaces 20, 22, 24, and circuits in the service provider network 12. A Network Element Identifier (NEID or TID) identifies each NE 14, 18 and an NE interface ID (IFID or AID) identifies a port card in the NE. The TIDs and AIDs are physical identifiers, i.e., the identifying codes are recorded at the NE or on each port card. Other physical identifiers include CLLI codes for NEs and CLEI codes for port cards. A network Operations Systems Support (OSS) 28 maintains a master data base of accounting and inventory records to track the physical network resources (e.g., NEs, equipment, and facilities) and logical service and network resources (e.g., customers, circuits, virtual circuits, trunks or virtual trunks) in the SP network 12. The network OSS 28 performs a variety of management functions, including accounting/inventory, fault management, configuration or provisioning management, performance monitoring, and security. Responsibility for the proper operation of the SP network 12 in support of the service resides with the network OSS 28.

During a typical flow of operations, a customer purchases a service from a service provider, resulting in a service order. A service Operations Systems Support (OSS) 26, managing the relationship with the customer, typically in accordance with a service level agreement (SLA), handles the order fulfillment, service assurance, and billing for the service. The service OSS 26 associates the customer information (e.g., customer address, contact information and service specific information) with the master database of the network OSS 28.

Upon receiving a service order from the service OSS 26, the network OSS 28 examines the SP resources at the various locations to identify the SP network resources that will support the service (e.g., from location A to location B). The network OSS 28 uses the CLLI to identify equipment at these locations and the CLEI to identify the physical equipment and port cards that will provide the circuit, virtual circuit, or path that will carry the service traffic. The network OSS 28 also searches its database for equipment at those location sites and at intermediate sites. Operations personnel then designs a circuit, virtual circuit, or path to transport the service traffic, assigns a logical circuit identifier (CID) to the circuit, virtual circuit, or path using a Common Language Circuit Identifier or CLCI code, and builds (i.e., configures) the circuit, virtual circuit or path. The circuit ID at the OSS level is associated with each NE (identified by a TID) and with each port card (AID) in the circuit. In traditional networks, the logical identifiers (CID) are maintained by the network OSS 28 only.

The network and service OSSs often employ these numbering or coding schemes to inventory and identify network equipment supporting a service. For example, occasionally conditions arise in the network 2 that can disrupt or degrade the service. Alarms reporting the problem pass to the network OSS 28 from a network element detecting the network condition. When passing an alarm or report to the network OSS 28, the network element reports the TID, AID, and channel information. The network OSS 28 forwards the circuit information and facility information to the service OSS 26. The service OSS 26 analyzes this information in an attempt to determine whether the network condition is affecting its service and whether such an effect is impacting the SLA.

Typically, however, the circuit and facility information passed to the service OSS 26 is insufficient to determine directly those services affected by the network condition. Generally, correlating these codes to services is onerous and requires coordination between the service OSS 26 and the network OSS 28. Either a proprietary translation method is needed to find common names associated with the numbered resources or no common naming features are used at all. Consequently, the service OSS 26 has difficulties readily determining whether its service is operating properly from the information provided to it from the network OSS 28. Thus, there is a need for a system and method for identifying service and management resources more efficiently than current numbering codes.

### SUMMARY

In one aspect, the invention features a method for identifying resources associated with a communications network. A structured address format is defined having a plurality of address segments. Each address segment of the format is associated generally with one or more properties of a managed resource of the private communications network. A structured address constructed according to the structured address format is assigned to the managed resource. Each address segment of the assigned structured address has a value that conveys information about one or more properties of the managed resource.

In another aspect, the invention features n inventory system for managing resources of a private communications network. The inventory system comprises a structured address format having a plurality of address segments. Each address segment is associated generally with one or more properties of a managed resource of the private communications network. The inventory system also includes means for assigning to the managed resource a structured address constructed according to the structured address format. Each address segment of the assigned structured address has a value that conveys information about one or more properties of the managed resource.

In yet another aspect, the invention features an operations support system comprising means for defining a structured address format having a plurality of address segments. Each address segment is associated generally with one or more properties of a managed resource of a private communications network. The operations support system also includes means for assigning to the managed resource a structured address constructed according to the structured address format. Each address segment of the assigned structured address has a value that conveys information about one or more properties of the managed resource.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram of an embodiment of a network using present-day numbering codes to identify network resources.

FIG. 2A is a diagram of an embodiment of a network using structured addressing of the invention to inventory and identify service and network resources.

FIG. 2B is a diagram of an embodiment of a network spanning multiple sub-networks, for example, Local Area Transport Areas (LATAs), and using structured addresses of the invention to associate a service and a path identifier with multiple circuit identifiers.

FIG. 3 is a diagram of an embodiment of a structured address format of the present invention for defining structured addresses that identify service resources.

FIG. 4A and FIG. 4B are diagrams of examples of associations between character positions of the structured address format of FIG. 3 and properties of a service resource.

FIG. 5 is a diagram of an embodiment of a structured address format for defining structured addresses that identify network resources.

FIG. 6 is a diagram of an example of a networking layer 2 structured address used to identify a service resource.

FIG. 7 is a diagram of an example of a networking layer 2 structured address used to identify a network resource.

### DETAILED DESCRIPTION

The present invention provides a naming and addressing mechanism that helps service and network Operations Support Systems (OSS) manage their specific services, facilities, and equipment. In brief overview, anything associated with a service or network can be given a private common name and a private structured address, described below. The service and network OSSs can each independently of the other assign names to logical and physical, service and network resources (hereafter referred to generally as managed resources). Managed resources include, but are not limited to, network elements, paths, connections, circuits, tunnels, services, port cards, trunks, office locations, network alarms, network performance, work orders, reports and general network OAM&P (Operations, Administration, Maintenance, and Provisioning). Generally, the service OSS assigns names to service resources and the network OSS to network resources. The assigned names are primarily alphanumeric and descriptive of the named resource so that OSS personnel can readily identify the named resource from the given name. Because alphanumeric names are more readily understood than numbering codes, the naming of managed resources facilitates the performance of operational processes and of customer care. These assigned names are hereafter referred to as common names.

Also associated with each managed resource is an address (or a code). Although referred to throughout this description as addresses, such addresses are not used for traffic routing purposes. The association of the address to the managed resource can be physical (i.e., the appropriate OSS records the address on the resource) or logical (i.e., the appropriate OSS maintains a document, table, or database cross-referencing the address with the resource). Preferably, the format of the address is structured; that is, each address is comprised of segments having one or more character positions, and a value given a particular address segment conveys information about a property or characteristic of the managed resource associated with that address. This structured format facilitates searching and mapping to assigned names. Given a name, the service OSS or network OSS can translate the name to a corresponding address; or given an address, translate to a name.

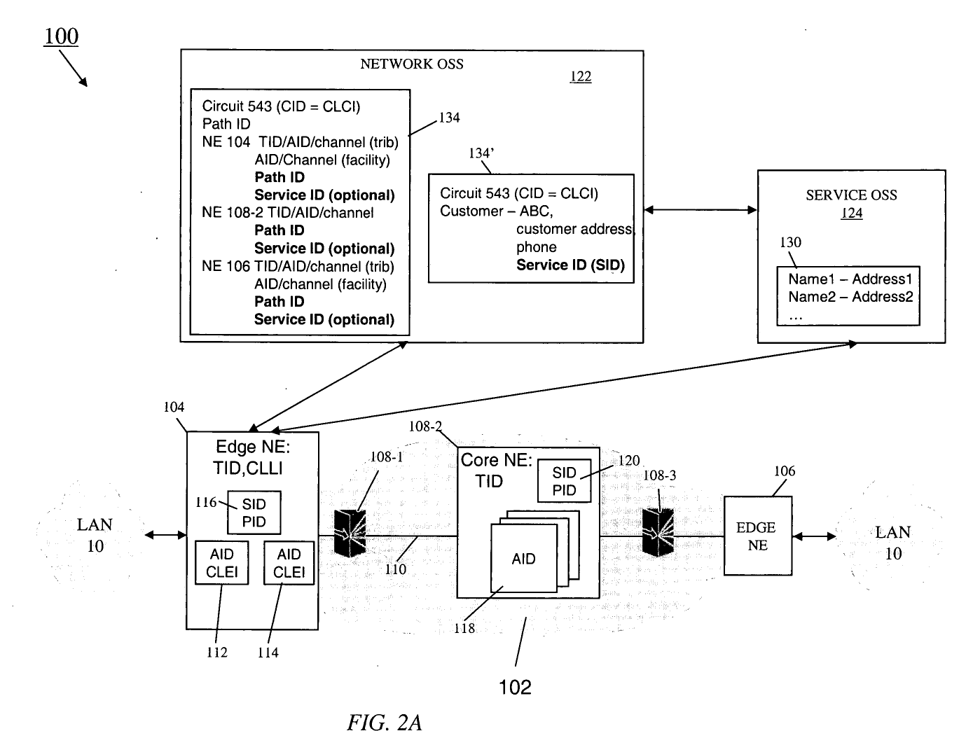

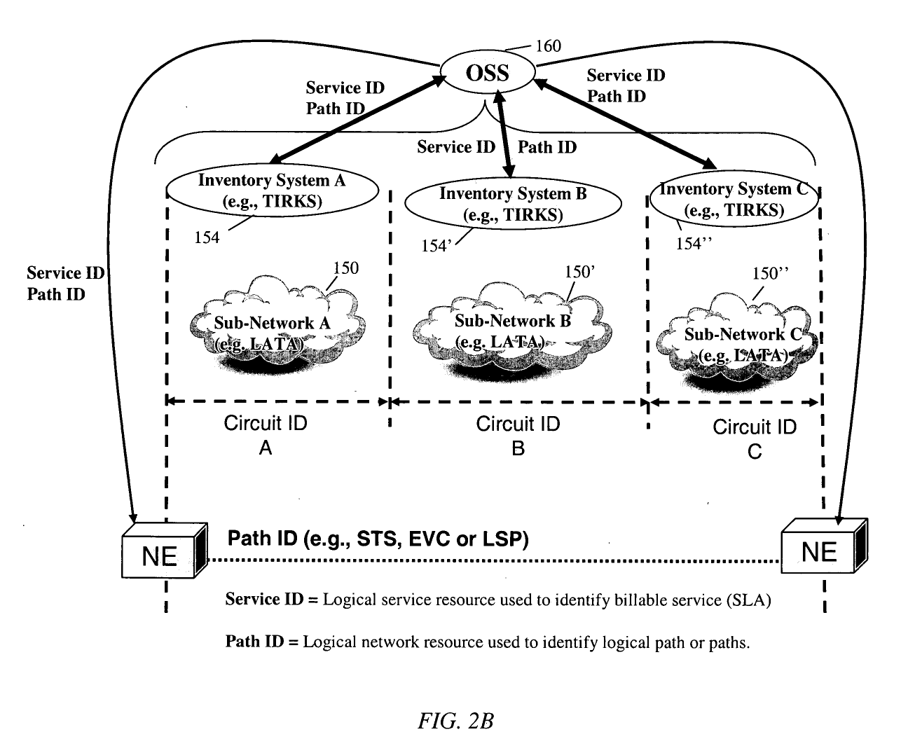

FIG. 2A shows an embodiment of a network 100 employing managed resource naming and addressing of the invention. The network 100 includes a plurality of LANs 10 in communication with each other over a service provider (SP) private network 102. As used herein, a private network means a network comprised of circuits known exclusively to and for the exclusive use of an organization or group of affiliated organizations. In one embodiment, the SP network 102 is a connectionless network (e.g., a local area network (LAN), metro-area network (MAN), or wide-area network (WAN). Examples of connectionless networks include IP networks, such as the Internet, private LANs and SANs, and private LAN enterprises. In another embodiment, the SP network 102 is a connection-oriented network, such as Multi-Protocol Label Switching (MPLS), Synchronous Optical Network (SONET), Synchronous Digital Hierarchy (SDH), or Optical Transport Network (OTN). In yet other embodiments, the SP network is a network of networks (i.e., of connectionless or circuit-oriented LANs, MANs, WANs, or combinations thereof), supported by one or more service providers (or carriers).

The SP network 102 has a variety of network resources, including a near-end edge-service node or network element (NE) 104 in communication with a far-end edge-service network element NE 106 through a plurality of intermediate or core network elements NE 108-1, 108-2, and 108-3 (generally, core NE 108). Transmission of service traffic among the NEs 104, 106, 108 is over a transport facility 110. In one embodiment, the transport facility 110 is an optical transport facility based on a synchronous data transmission standard such as SONET. Other types of transport facilities than optical transport can be used, such as wired or wireless transport, without departing from the principles of the invention. Each edge-service NE 104, 106 includes a tributary interface 112 and a line interface 114 (which are not shown for NE 106). The core NEs 108 include line interfaces 118 (shown in representative core NE 108-2).

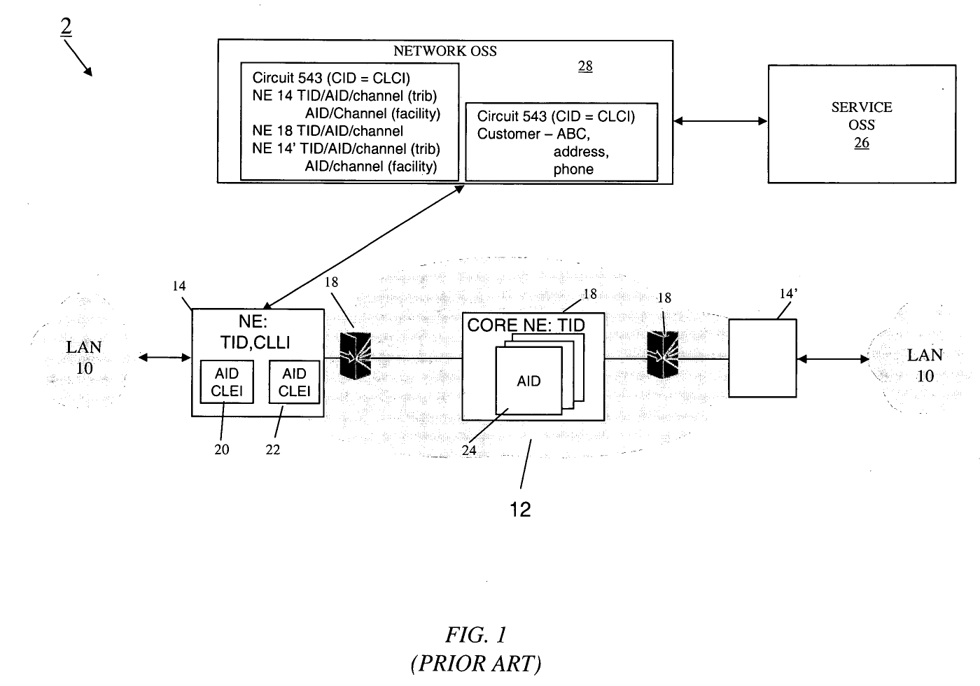

In the embodiment shown, the SP network 102 employs conventional coding mechanisms described in FIG. 1 for identifying the NEs 104, 106, 108 and interfaces 112, 114, 118 (e.g., TIDs, AIDs, CLEIs, and CLLIs). As a supplement or alternative to these conventional coding mechanisms, the SP network 102 employs the addressing mechanism of the present invention. Here, the addressing mechanism is embodied in a service identifier (SID) and a path identifier (PID), collectively denoted by reference numeral 116 at the near-end NE 104 and by reference numeral 120 at the core NE 108. Such service and path identifiers illustrate addressing for two examples of managed resources; namely, the service being supported by the SP network 102 and the path taken by the service traffic through the SP network 102. In one embodiment, the SID and PID are recorded at each of the edge-service NEs 104, 106 and at the core NE 108-2. Typically, the SID and PID are recorded at the edge-service NEs 104, 106 when the service is provisioned and the core NEs 108 learn these addresses from the contents of the service traffic passing therethrough.

In accordance with the invention, a service OSS 124 generates and assigns the SID in the network OSS 128 inventory and provisions the SID at the near-end NE 104 upon configuring or commissioning the service to be transported over the SP's private network 102. The service OSS 124 also assigns a common name to the SID (e.g., “ACME/OttawaBoston/E-line/VPN”). A database or records 130 maintained by the service OSS 124 associates the assigned common name to the SID.

SIDs can be used to augment or extend the capabilities of traditional inventory systems, for example, by associating SIDs with one or more traditional CIDs (CLCI). Accordingly, SIDs can be added to the Network OSS records or databases, assigned to CIDs within a traditional inventory system, such as the Trunks Integrated Record Keeping System (TIRKS), or both.

In some instances, a SID can be used to associate two or more different CIDs. FIG. 2B illustrates such an example for a service that traverses multiple distinct sub-networks 150, 150′, 150″ (generally, sub-network 150) over a single path. Local Access Transport Areas or LATAs are examples of the sub-networks 150. Each sub-network 150 is administered as a separate private network and employs a separate inventory system 154, 154′, and 154″ (generally, inventory system 154). An example of such an inventory system is TIRKS. For each sub-network 150, a different CID is associated with the service. Each different CID corresponds to a different section of the full path. Here, the different CIDs are identified as Circuit ID A, Circuit ID B, and Circuit ID C.

An OSS 160 oversees the operation of the service from end to end between the NEs 164, 164′ and has access to each of the inventory systems 154. Into each of these inventory systems 154 the OSS 160 stores the SID, PID, and the different CIDs associated with the service. Accordingly, in this example, a single SID and a single PID are each associated with three different CIDs. Further, in these inventory systems, the SID and PID can each be used to associate the different CIDs with each other.

As another example, a single SID can be assigned and associated with two or more different CIDs when a single data service requires two or more separate circuits to operate. For example, consider an Ethernet Private Line (EPL) service transported using Virtual Concatenation (VCAT) with 3×STS-n, DDS-56K and Error Correction via 2× DS0. In this example, illustrated by the third row of TABLE 1 below, a single service ID is associated with two different path IDs (path ID A and path ID B). Each path ID corresponds to one of the separate circuits and is associated with a different one of the CIDs. TABLE 1 also illustrates other examples of 1:N:N relationships among SIDs, PIDs, and CIDs for various types of services in four different types of networks: 1) Digital networks; 2) Optical networks; 3) Ethernet networks; and 4) IP/MPLS networks. The examples are merely illustrative, and are not intended to be representative of all possible associations among SIDs, PIDs, and CIDs.

TABLE 1

| Service ID: Path ID: Circuit ID | | | | | | | |
|---|---|---|---|---|---|---|---|
| Associations | | | 1:N:N | Digital | Optical | Ethernet | IP/MPLS |
| Service ID [symbol] | Path ID [symbol] | Circuit ID | 1:1:1 | DS0 PL | OC-n PL | EVC | LSP |
| | | | | DS1 PL | EPL (STS-nc) | | |
| | | | | DS3 PL | | | |
| | [symbol] | Circuit ID A | 1:1:3 | Cross- | Cross-LATA | Metro/ | Metro/ |
| Service ID [symbol] | Path ID [symbol] | Circuit ID B | | ATA | Metro/ | National/Global | National/Global |
| | [symbol] | Circuit ID A | | Metro/National | National | | |
| Service ID [symbol] | Path ID A [symbol] | Circuit ID A | | DDS | OC-n PL (N x | Protected EVC | Protected LSP |
| [symbol] | Path ID B [symbol] | Circuit ID B | 1:2:2 | Inverse Mux | STS) EPL (STS-nvc) | | |

Similarly, a network OSS 122 can generate and store the PID at the near-end NE 104 upon designing the circuit, virtual circuit, path, tunnel, or connection (hereafter generally referred to as circuit) to be taken by the service traffic, add the PID to the inventory system (e.g., TIRKS), and associate the PID with a common name. The network OSS 122 maintains records that include the PID and, optionally, the service ID. For example, consider that the network OSS 122 maintains a record 134 of a circuit (referred to, for example, as circuit 543) that includes a plurality of NEs (numbered 90, 128, and 495). The PID appears under the heading for the circuit 543 and for each of these NEs. Optionally, the SID appears under the heading for each NE, too. In this example, the addresses of the invention (here, e.g., the SID and PID) are supplemental to the numbering systems of conventional systems; that is, the PID and SID are added to the conventional inventory formats (e.g., Telecordia Technologies formats, such as CLCI (common language circuit identifier) and CLFI (common language facility identifier), and conventional TL-1 structures, such as TID and AID), or to other numbering codes of traditional OSS systems. The addition of SIDs (and PIDs) to traditional inventory systems enables the use of conventional searching techniques to find common names associated with logical and physical network and service resources.

When, in the operation of the SP network 102, any of the NEs 104, 106, 108 produce a report (e.g., performance monitor, alarm), that report can include one or both of the SID and the PID. For example, service reports containing performance metrics and availability of service metrics also contain the SID for the measured service and, optionally, the PID of the path supporting that service. Network or path reports raising alarms or reporting performance and availability metrics for the path contain the PID of the path, and, optionally, the SID of each service transported over the path. These network or path reports can also include the traditional TID/AID/Channel and Port ID identifiers. Alternatively, the network OSS 122, service OSS 124, or both can dynamically access one of the NEs 104, 106, 108 to obtain the PID and SID information recorded thereat. From the PID and the SID, the network OSS 122 or service OSS 124 can access its own locally kept records 134, 130 to readily determine the common names of the service and network resources described by the reports.

Addresses associated with managed resources are preferably structured addresses, as described below. As used herein, structured means that the individual segments that make up an address each independently convey meaning about the managed resource. Address segments include one or more characters. For example, the position and value of each digit or character in an address segment has significance, i.e., to convey certain information about a property of the managed resource. Accordingly, the characters of a structured address individually and collectively convey information.

The format of a structured address of the invention can follow the format of any conventional or proprietary physical or logical address. Examples of such formats include, but are not limited to, NSAP, Transport Network Address (TNA), Q-tags, CLEI codes, Media Access Control (MAC) addresses, 32-bit MPLS labels, IPv4 addresses, and IPv6 addresses. In a preferred embodiment, structured addresses of the invention have a similar format as that of IPv4 addresses (i.e., four-byte dotted decimal notation). Unlike IPv4 addresses, which are used to identify host interfaces for the purpose of routing traffic through the Internet, the four-byte embodiment of a structured address of the invention operates to identify properties or characteristics of managed resources in a communications network.

An advantage of structuring addresses similarly to the IPv4 address format is the abundance of currently available tools and tool sets for performing address-to-name and name-to-address translation. Specifically, the standard IP domain name system (DNS), for example, which was developed to translate between domain names and IP addresses and to route Internet traffic, can be used with the present invention to perform the address to common name translations. An exemplary implementation of the DNS, in general, entails the use of two large tables: one table translates from addresses to common names; the other translates from common names to addresses. The one table has a first column containing four-byte integers representing addresses and a second column containing DNS strings representing common names. The other table has a first column containing DNS strings representing common names and a second column containing four-byte integers representing addresses. Standard search engines can also be used with the present invention, thus providing inventory search features superior to traditional inventory system.

Structured addresses, in one embodiment, are also private in that the each service OSS and each network OSS generates, distributes, and maintains its own set of addresses (i.e., each possesses its own private addressing system). Generally, each OSS 122, 124 can employ its full range of addresses (as that OSS defines that address range), and associate such addresses with managed resources independently of the address associations made by other organizations; to take advantage, however, of existing DNS tools, those embodiments of structured addresses adhering to the four-byte IPv4 address format are limited to the address range conventionally allocated to IPv4 addresses (i.e., each byte of the four-byte structured address is within the range of 0 to 255, inclusive). Within each OSS, each address in the set of addresses is unique, but the addresses of one OSS need not be unique from those of another OSS (or from one organization or entity to another organization or entity). Each network and service OSS 122, 124 can maintain its own DNS service and its own naming conventions and databases and perform its own searches and inventorying. Provided different OSSs employ the same structured format for its addresses, currently available tools facilitate the merging of distinct address systems, thus simplifying the combining of separately developed inventory systems that employ the naming and addressing mechanism of the invention. An example of a tool for translating addresses defined according to one structured address format into addresses constructed according a second structured address format is the Network Address Translation (NAT) tool. Accordingly, OSSs can use standard NAT tools to translate between different service resource databases and between different network resource databases.

Addresses (i.e., structured, private, or both) can be assigned to a wide variety of physical managed resources and logical managed resources at different levels of networking, e.g., at the network element (NE) level, at an Element Management System (EMS) level, at the OSS level or at any combination thereof. Addresses can also be implemented at different layers of networking, e.g., at layer 1 (physical layer), at layer 2 (data link layer, including MAC sub-layer), and at layer 3 (networking layer), or combinations thereof. For example, addresses can be associated with specific named, managed resources, such as optical User Network Interface (UNI) ports (UNI ID), specific service interfaces associated with customer interfaces, specific service paths or end-to-end circuits (i.e., Circuit ID, Port ID), services (Service ID or SID), equipment such as network elements (NE), port cards, office locations (i.e., NE ID, Card ID, Location ID), and paths, connections and/or tunnels (Path ID, Connection ID, Label Switched Path (LSP ID), Layer 2 Tunneling Protocol (L2TP ID)). Common names and addresses can also be associated with network alarms, network performance, network work orders, reports and general network OAM&P.

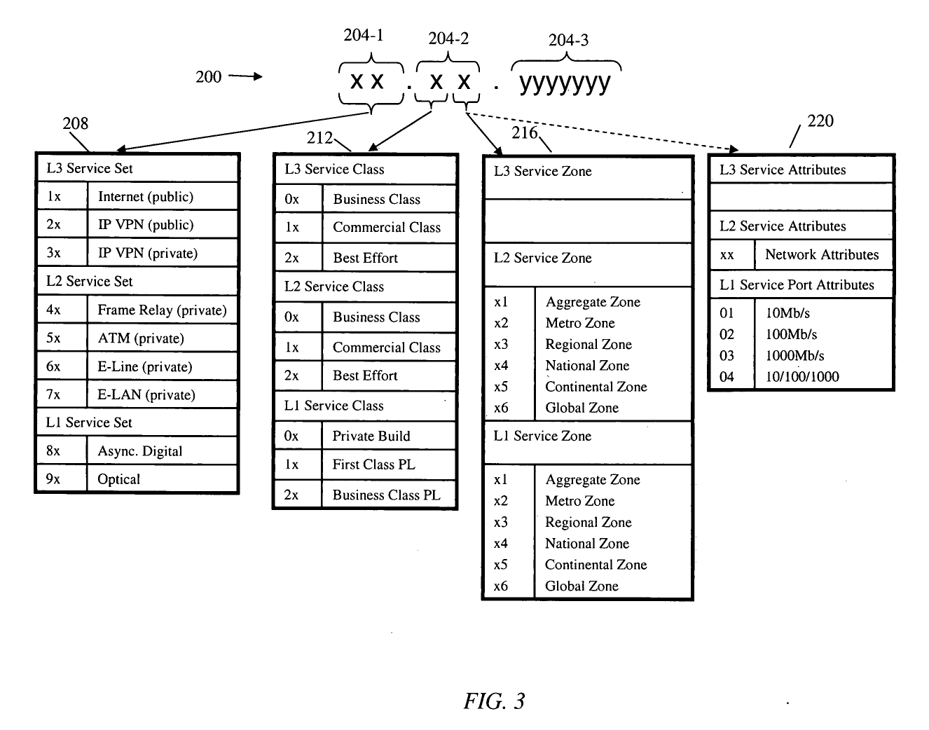

FIG. 3 shows an exemplary embodiment of a structured address format 200 having a plurality of digit or character positions divided into address segments 204-1, 204-2, 204-3 (generally, address segment 204) separated by decimal points. Each character position is associated generally with a property of a managed resource. The managed resource in this example is a service, and properties of this service include type of service, class of service, service zone, and numbered instance of the service. Addresses constructed according to this structured address format 200 have character positions associated with each of these properties of the managed resource. For instance, the address segment 204-1 has two character positions for identifying a service type 208, address segment 204-2 has one character position for identifying a service class 212 and another character position for identifying a service zone, or, alternatively, a service attribute, and address segment 204-3 has a plurality of character positions for identifying particular instances of services. The structured address format 200 is merely exemplary; a structured address of the invention can have, for example, fewer or more address segments, address segments with different associated meanings, a different hierarchical order of address segments, different delimiters than decimal points or no delimiters, and fewer or more characters per address segment without departing from the principles of the invention.

The types of services in the service set 208 are logically organized according to the networking layers (Layer 1, Layer 2, and Layer 3 service sets) typically associated with supporting the services. For example, Internet services are within the Layer 3 service set (e.g., 1×), Ethernet-LAN services (e.g., 7×) are within the Layer 2 service set, and digital and optical services (e.g., 8× and 9×, respectively) are within the Layer 1 service set. The organization according to networking layers extends to each of the address segments 204. This organization according to networking layers is merely exemplary. Other techniques for categorizing services can be used without departing from the principles of the invention.

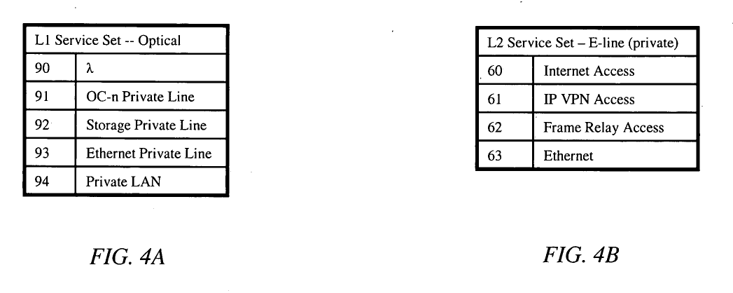

In more detail, each character position of the address segment 204-1 (corresponding to the service set 208) operates to distinguish the type of service (an “x” is a placeholder for any value). The value assigned to the most significant character in the service set 208 determines the general type of service: e.g., an “8” value indicates a digital service, such as DS1; a “9” value indicates an optical service. The value of the next character in the service set 208 identifies the service type more specifically. For example, as shown in FIG. 4A, the value of the first character identifies an instance of a type of service (here a “9” value identifies optical services generally), and the value of the second character identifies a specific instance of an optical service (e.g., wavelength, OC-n private line, storage private line, Ethernet private line, and private LAN). As another example, shown in FIG. 4B, a value of “6” for the first character identifies E-line services as a specific instance of a type of service, and the value of the second character identifies a specific instance of an E-line service (e.g., Internet, IP Virtual Private Network, Frame Relay, and Ethernet). Although in each of the described examples the value assigned to each character of the structured address is numeric, it is to be understood that values can also be alphabet characters and symbols such as #, *, and & without departing from the principles of the invention.

The first character of the address segment 204-2 determines the service class 212 of the service traffic, examples of which include business class, commercial class, and best effort. In one embodiment, the second character indicates the zone (i.e., the geographical reach) to which the service traffic can travel. For example, six zones are defined: aggregate zone, metro zone, regional zone, national zone, continental zone, global zone. More or fewer zones can be defined. Zoning is described in more detail in U.S. patent application Ser. No. 10/741,988, filed on Dec. 19, 2003, and titled “Zoning for Distance Pricing and Network Engineering in Connectionless and Connection-Oriented Networks,” the entirety of which application is incorporated by reference herein. In another embodiment, the second character of the address segment 204-2 identifies service attributes, such as network attributes, port attributes (e.g., 10 Mbps, 100 Mbps, 1000 Mbps, 10/100/1000 port, etc.), and path attributes. The last address segment 204-3 of this particular example identifies the particular service instance. In one embodiment, each service instance corresponds to a seven-digit telephone number (i.e., without an area code). The seven digits for the service instance can be represented by 20 data bits (i.e., 2²⁰ different service instances).

The service OSS 124 can use the above described address format 200 for identifying service resources of particular interest. For example, the service OSS 124 defines service identifiers (SIDs) that adhere to the format of the structured address 200. Consider, for example, optical administration (layer 1) for a service ID of 93.24.5552684, defined in accordance with the structured address format 200 of FIG. 3. This corresponds to the following service resources: the service is Ethernet Private Line (93), the service class is Business Class PL (2), the service reaches the National Zone (4), and the service instance is 5552684. Note that in this example, the second character of the address segment 204-2 identifies the zone.

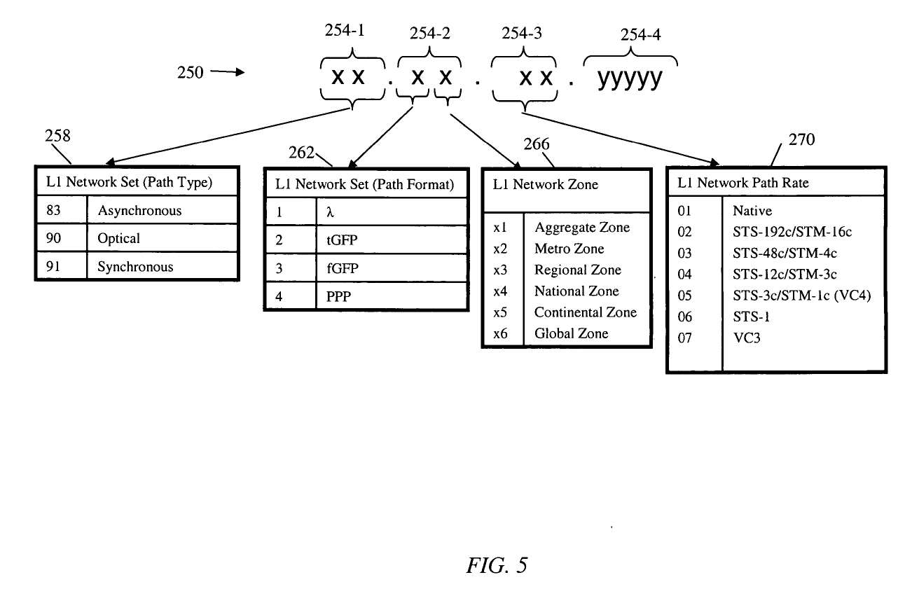

As described above, the network OSS 122 can also use structured addresses for identifying network resources. The structured address format can be the same as or different than the exemplary structured address 200 described above for identifying optical (Layer 1) network resources. For example, FIG. 5 shows an embodiment of a structured address format 250 including segments 254-1, 254-2, 254-3, 254-4 (generally, address segment 254), separated by decimal points. Address segment 254-1 identifies a type of path 258, address segment 254-2 identifies the path format 262 and service zone, address segment 254-3 identifies path rate 270, and address segment 254-4 identifies the particular numbered instance of a path. Again, the structured address format 250 is merely exemplary. Consider, for example, a path ID of 91.36.5.76335684. This corresponds to the following network resources: type of path is Synchronous optical (91), the path format is framed Generic Framing Procedure or fGFP (3), the path reach is the Global Zone (6), the path rate is STS-3c (5), and the path instance is number 76335684.

The present invention enables inventorying of services and network resources unattainable with conventional numbering schemes. For example, consider that the network OSS 122 desires to know the number of DS1 ports on a particular network element. Until the present invention, the network OSS 122 could only obtain TID/AID/channel and port ID information from the NE, but could not correlate these numbers directly to DS1 ports. With the present invention, DS1 ports are assigned structured addresses with a particular prefix (e.g., 83). A search performed by the network OSS 122 for structured addresses at the NE then generates a list of structured addresses having the particular prefix. Each structured address could then be cross-referenced to a common name. The service OSS 124 can perform similar queries with regards to the types of services supported by particular network elements.

The SID and PID described in FIG. 3 and FIG. 5 are examples of layer 1 addresses. Structured addresses for service and network resources can also be implemented at the layer 2 and layer 3 networking layers. Because of the connectionless nature of such networking layers, the structured addresses are conveyed by the packets of the service traffic, in contrast to the layer 1 addresses, which are stored at the network equipment. From these service packets, each node or NE in the path of the service traffic can thus learn the SID and PID associated with the service traffic.

A variety of techniques can be employed to convey structured packets at the layer 2 and layer 3 networking layers. For example, existing Ethernet Virtual Local Area Network (VLAN) technology can be used to convey structured addresses. For tag-based Ethernet VLANs, each packet has a MAC header that includes a tag, called a q-tag. Certain bits of the q-tag identify the VLAN group membership (VLAN ID). In one embodiment, an NE can correlate the value of these bits to a particular structured address. In another embodiment, the VLAN ID explicitly carries a structured address. As yet another example, an NE receiving a packet can add a field, such as a second VLAN ID, to that packet, to carry explicitly a structured address or a value that correlates to a structured address. One skilled in the art will recognize other ways for conveying structured addresses in the service packets, such as including the structured address in MPLS tunnel labels and Pseudo-Wire Emulation Virtual Channel (PWE VC) labels.

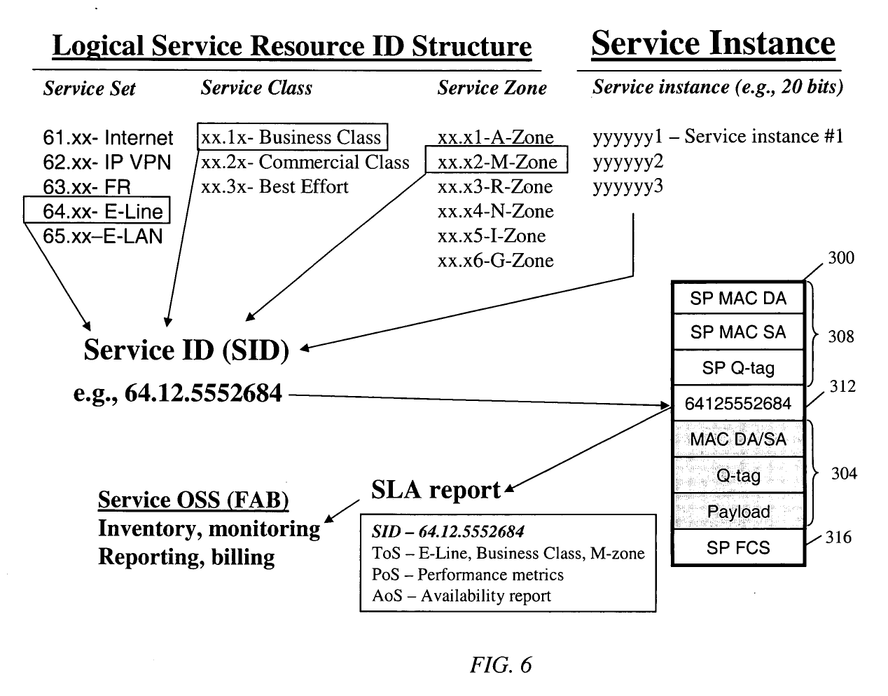

FIG. 6 illustrates an example of a layer 2 implementation for transporting structured addresses associated with a service resource over the communications network 102. A packet 300 encapsulates an Ethernet packet 304 received from the client LAN 10 (FIG. 1). To encapsulate the packet 304, the edge-service NE 104 prefixes source and destination address (SA/DA) fields, a Q-tag field (collectively, 308, with the SA/DA fields), and a service ID field 312 before the header of the packet 300 and appends a frame check sequence (FCS) field 316 to the end of the packet 300. The NE 104 adds the SID assigned to the service to the service ID field 312. Here, for example, the SID is 64.12.5552684. From this address, the following meaning can be determined: the type of service (ToS) is an Ethernet E-line service; the class of the service is business class; the reach of the service is metro-zone; and the service instance is number 5552684. Service level agreement reports sent to the service OSS 124 include the SID among other data such as the type of service (ToS), the performance of the service (PoS), and the availability of service (AoS). Techniques for measuring PoS and AoS metrics are described in U.S. patent application Ser. No. 10/741,296, filed on Dec. 19, 2003, and titled “Service Metrics for Managing Services Transported over Circuit-Oriented and Connectionless Networks,” the entirety of which application is incorporated by reference herein.

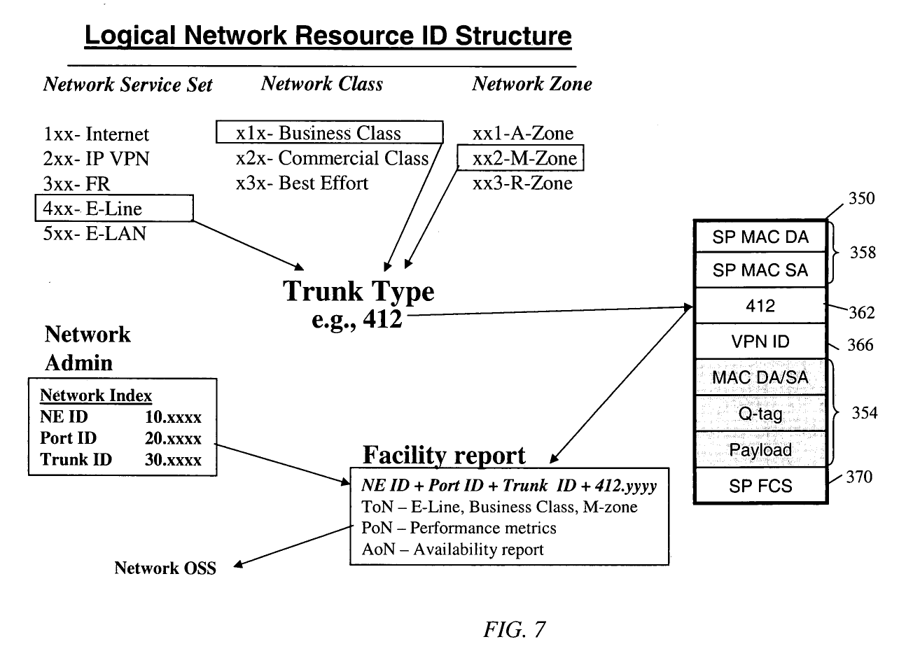

FIG. 7 illustrates an example of a layer 2 implementation for transporting a structured address associated with a network resource over the communications network 102. A packet 350 encapsulates an Ethernet packet 354 received from the client LAN 10 by prefixing source and destination address (SA/DA) fields 358, a network resource ID field 362, and a Virtual Private Network (VPN) ID field 366 at the header of the packet 354 and by appending a frame check sequence (FCS) field 370 to the end of the packet 354. A structured address assigned to network resource is stored in the network resource ID field 362. For example, in FIG. 7, a structured address value of 412 is associated with a type of trunk: the value of 4 in the first character position indicates the trunk type is for an Ethernet E-Line service; the value of 1 in the second character position indicates that the service class is business class, and the value of 2 in the third character position indicates that the reach of the service is the metro-zone. As described above, a variety of techniques can be used to implement the network resource ID field 362 including an MPLS label and VLAN ID. Facility reports sent to the network OSS 124 include the trunk ID taken from the packet 350, among other data such as the type of network (ToN), the performance of the network (PoN), and the availability of network (AoN). Other identifiers, such as the network element ID (NEID), port ID (AID) and trunk ID can also be included in such facility reports.

While the invention has been shown and described with reference to specific preferred embodiments, it should be understood by those skilled in the art that various changes in form and detail may be made therein without departing from the spirit and scope of the invention as defined by the following claims.

1. A method for identifying resources associated with a communications network, the method comprising:
defining a structured address format having a plurality of address segments, each address segment being associated generally with one or more properties of a managed resource of the communications network; and
assigning to the managed resource a structured address constructed according to the structured address format, each address segment of the assigned structured address having a value that conveys information about one or more properties of the managed resource.

2. The method of claim 1, further comprising assigning a name to the managed resource and associating the name with the structured address assigned to the managed resource.

3. The method of claim 2, further comprising translating between the name and the structured address assigned to the managed resource using a domain name system service.

4. The method of claim 1, further comprising storing the structured address in an inventory system used by an operations system support (OSS) to support the communications network.

5. The method of claim 1, further comprising storing the structured address at a network element in the communications network.

6. The method of claim 1, further comprising transmitting the structured address assigned to the managed resource over the communications network in a packet.

7. The method of claim 1, further comprising producing by a network element in the communications network a report containing the structured address assigned to the managed resource.

8. The method of claim 1, wherein a value assigned to one of the address segments in the structured address operates to identify a zone in the communications network to which service traffic can be transported.

9. The method of claim 1, wherein a value assigned to one of the address segments of the structured address operates to identify a type of service.

10. The method of claim 1, wherein a value assigned to one of the address segments of the structured address operates to identify a transmission bit rate for service traffic over the communications network.

11. The method of claim 1, wherein the private communications network includes one of an optical network, an Ethernet network, and an Internet Protocol network.

12. The method of claim 1, wherein the structured address format includes a dotted decimal notation.

13. The method of claim 1, wherein the managed resource is a data service and the structured address operates as a service identifier.

14. The method of clam 1, wherein the managed resource is a path through the communications network over which service traffic is transported and the structured address operates as a path identifier.

15. The method of claim 1, wherein the structured address is a private address.

16. The method of claim 1, wherein the structured address format is a first structured address format, and further comprising translating the structured addresses defined according to the first structured address format into structured addresses defined according to a second structured address format.

17. The method of claim 1, further comprising querying a network element in the communications network to take an inventory of managed resources based on structured addresses recorded by the network element.

18. The method of claim 1, wherein the communications network supports circuit-based communications, packet-based communications, or a combination thereof.

19. The method of claim 1, further comprising incorporating the structured address assigned to the managed resource in an inventory system of an operations support system.

20. The method of claim 1, further comprising:
associating a first circuit identifier with a path by which traffic of a service is transported over the communications network; and
associating the structured address with the first circuit identifier.

21. The method of claim 20, further comprising:
associating a second circuit identifier with the path; and
associating the structured address with the second circuit identifier.

22. The method of claim 20, further comprising:
associating a second circuit identifier with a second path by which traffic of the service is transported over the communications network; and
associating the structured address with the second circuit identifier.

23. An inventory system for managing resources of a private communications network, the inventory system comprising:
a structured address format having a plurality of address segments, each address segment being associated generally with one or more properties of a managed resource of the private communications network; and
means for assigning to the managed resource a structured address constructed according to the structured address format, each address segment of the assigned structured address having a value that conveys information about one or more properties of the managed resource.

24. The inventory system of claim 23, further comprising means for translating structured addresses defined according to the structured address format into structured addresses defined according to a second structured address format.

25. The inventory system of claim 23, further comprising means for associating a name with the structured address assigned to the managed resource.

26. The inventory system of claim 25, further comprising means for translating between the name and the structured address assigned to the managed resource.

27. An operations support system, comprising:
means for defining a structured address format having a plurality of address segments, each address segment being associated generally with one or more properties of a managed resource of a private communications network; and
means for assigning to the managed resource a structured address constructed according to the structured address format, each address segment of the assigned structured address having a value that conveys information about one or more properties of the managed resource.

28. The inventory system of claim 27, further comprising means for translating structured addresses defined according to the structured address format into structured addresses defined according to a second structured address format.

29. The inventory system of claim 27, further comprising means for associating a name with the structured address assigned to the managed resource.

30. The inventory system of claim 29, further comprising means for translating between the name and the structured address assigned to the managed resource.
